(19) United States
(12) Patent Application Publication
(10) Pub. No.: US 2023/0073919 A1
(43) Pub. Date: Mar. 9, 2023

(54) BATTERY MODULE AND SPACER

(71) Applicant: PRIMEARTH EV ENERGY CO., LTD., Kosai-shi (JP)

(72) Inventor: Kousuke MURAISHI, Hamamatsu-shi (JP)

(73) Assignee: PRIMEARTH EV ENERGY CO., LTD., Kosai-shi (JP)

(21) Appl. No.: 17/683,480

(22) Filed: Mar. 1, 2022

(30) Foreign Application Priority Data
Aug. 27, 2021 (JP) 2021-138802

(51) Int. Cl. H01M 50/289; H01M 10/613; H01M 10/647; H01M 10/6557; H01M 10/6561; H01M 50/209

(52) U.S. Cl. CPC H01M 50/289; H01M 10/613; H01M 10/647; H01M 10/6557; H01M 10/6561; H01M 50/209

(57) ABSTRACT

A spacer of a battery module includes a plurality of bars provided extending in a width direction of adjacent battery cells and arranged at an interval from each other, a first fin, and a second fin. The first fin of the battery module takes a shape extending upward from the bar toward one of the battery cells and contact a principal surface of the battery cell. The second fin takes a shape extending downward from the bar toward the other battery cell and contact a principal surface of the other battery cell. A fin length of the first fin and a fin length of the second fin are each smaller than the interval between the bars. The sum of those fin lengths is larger than the interval between the bars.

### CROSS-REFERENCE TO RELATED APPLICATIONS

This application is based upon and claims the benefit of priority to Japanese Patent Application No. 2021-138802 filed on Aug. 27, 2021, the entire contents of which are incorporated herein by reference.

### BACKGROUND

### Technical Field

The present disclosure relates to a battery module consisting of a plurality of battery cells and a plurality of synthetic-resin spacers, which are alternately stacked one on another so that each spacer is placed between adjacent battery cells, and also relates to the synthetic-resin spacers placed between the battery cells constituting the battery module.

### Related Art

As a conventional battery module, one example is disclosed in Japanese unexamined patent application publication No. 2014-082170. In the battery module in this publication, spacers are each placed between adjacent battery cells. Each spacer has a wall part that is sandwiched between principal surfaces of adjacent battery cells and formed with cutout portions penetrating through the wall part in a thickness direction. Those spacers allow cooling gas to pass through the cutout portions, thus reducing an increase in temperature difference between the battery cells placed adjacently through the spacer.

### SUMMARY

### Technical Problems

In the aforementioned conventional art, there is a possibility that the cooling-gas passage that penetrates through the spacer in the thickness direction may become narrowed than expected. Specifically, each battery cell in the battery module may expand, i.e., swell, due to the increase in internal pressure caused by gas generated in a casing of each battery cell. A part of this swollen battery cell may enter into the cooling-gas passage provided in the spacer. In other words, in case the battery cell swells, the cooling-gas passage of the spacer may become narrowed than when the battery cell does not swell. In this case, the battery cells could not be appropriately cooled.

The present disclosure has been made to address the above problems and has a purpose to provide a battery module in which battery cells are arranged with an adequate space provided therebetween to appropriately cool the battery cells, and a spacer.

### Means of Solving the Problems

To achieve the above-mentioned purpose, one aspect of the present disclosure provides a battery module comprising: a plurality of battery cells, each having a principal surface; and a plurality of spacers made of synthetic resin and each placed between the battery cells so that the battery cells and the spacers are alternately stacked one on another, wherein each of the spacers comprises: a plurality of bars provided extending in a direction from one end to another end of each principal surface of the battery cells adjacently located on both sides of each spacer, the bars being arranged at an interval from each other; a first fin extending from at least one of the bars toward one of the adjacent battery cells and in a first direction from the bars and contacting the principal surface of the one battery cell; and a second fin extending from at least one of the bars toward another battery cell of the adjacent cells and in a second direction from the bars, opposite to the first direction, and contacting the principal surface of the other battery cell, the first fin has a first fin length which is an extending length from the bar in the first direction and the second fin has a second fin length which is an extending length from the bar in the second direction, each of the first fin length and the second fin length is smaller than an interval between the bars, and a sum of the first fin length and the second fin length is larger than the interval between the bars.

In the battery module configured as above, the first and second fins can appropriately make sure that the space is formed between the bars with an appropriate dimension between the adjacent battery cells. This is because the first fin can press a region of the battery cell located opposite to a region not pressed by the second fin in the arrangement direction of the bars. This configuration can prevent, for example, the principal surface of the swollen battery cell from entering into the space between the bars. Thus, the heat from the adjacent battery cells is appropriately dissipated into the space between the bars, thereby appropriately cooling the battery cells.

Another aspect of the present disclosure provides a spacer made of synthetic resin and to be placed between a plurality of battery cells each having a principal surface and constituting a battery module, the spacer comprising: a plurality of bars provided extending in a direction from one end to another end of each principal surface of the battery cells adjacently located on both sides of the spacer, the bars being arranged at an interval from each other; a first fin extending from at least one of the bars toward one of the battery cells in an oblique direction; and a second fin extending from at least one of the bars toward another battery cell and in an oblique direction opposite to the oblique direction of the first fin, wherein the first fin has a first fin length which is an extending length and the second fin has a second fin length which is an extending length, each of the first fin length and the second fin length is smaller than an interval between the bars, a sum of the first fin length and the second fin length is larger than the interval between the bars, and a sum of a projected length of the first fin with the first fin length with respect to an arrangement direction of the bars and a projected length of the second fin with the second fin length with respect to the arrangement direction of the bars is smaller than the interval between the bars.

In the spacer configured as above, the first and second fins can appropriately make sure that the space is formed between the bars with an appropriate dimension between the adjacent battery cells. This is because the first fin can press a region of the battery cell located opposite to a region not pressed by the second fin in the arrangement direction of the bars. The same applies to the second fin. This configuration can prevent, for example, the principal surface of the swollen battery cell from entering into the space between the bars. Thus, the heat from the adjacent battery cells is appropriately dissipated into the space between the bars, thereby appropriately cooling the battery cells. Furthermore, the sum of the projected length of the first fin and the projected length of the second fin with respect to the arrangement direction of the bars is smaller than the interval between the bars. Thus, the spacer can be produced at low costs without the use of a complicated die.

According to the present disclosure, a battery module capable of appropriately ensuring a space between battery cells to appropriately cool the battery cells, and a spacer.

### BRIEF DESCRIPTION OF THE DRAWINGS

FIG. 1 is an external perspective view of a battery module in embodiments;

FIG. 2 is a cross-sectional view of the battery module taken along A-A in

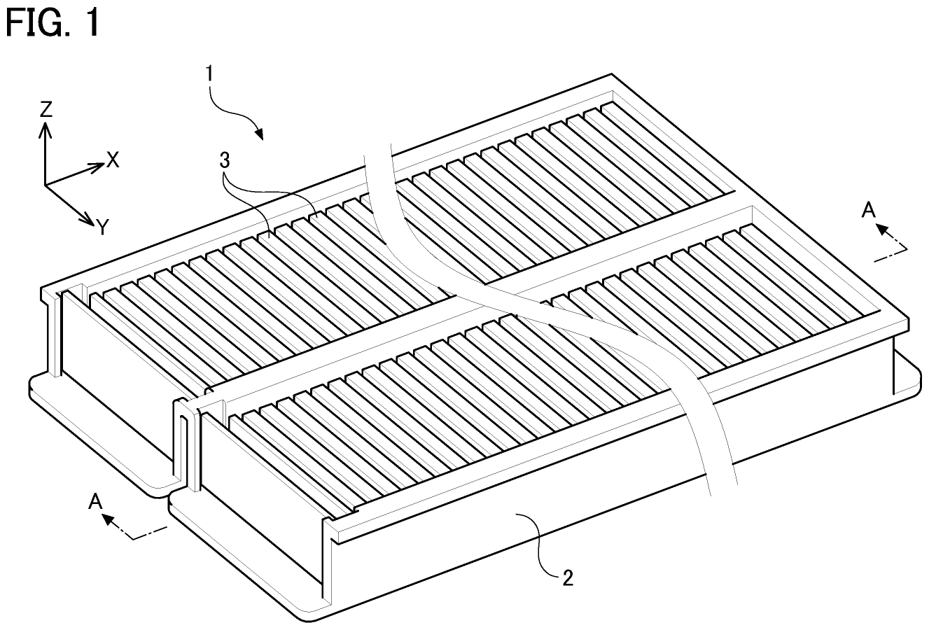

FIG. 1;

FIG. 3 is a perspective view of a spacer;

FIG. 4 is a cross-sectional view of a space-forming part in an uncompressed state in a first embodiment;

FIG. 5 is a cross-sectional view of the space-forming part in a compressed state in the first embodiment;

FIG. 6 is an explanatory diagram showing a molding die for injection molding of the spacer;

FIG. 7 is an explanatory diagram showing a space-forming part in a second embodiment; and

FIG. 8 is an explanatory diagram showing the space-forming part in the first embodiment when a battery cell is largely swollen.

### DETAILED DESCRIPTION OF THE EXEMPLARY EMBODIMENTS

A detailed description of first and second embodiments of the present disclosure will now be given referring to the accompanying drawings. The first embodiment will be first described and then the second embodiment will be described with a focus on differences from the first embodiment.

### First Embodiment

In the first embodiment, the present disclosure is applied to a battery module 1, the entire configuration of which is shown in FIG. 1. FIG. 1 illustrates the battery module 1 in which a plurality of battery cells 3 are packed in a lower case 2. Each battery cell 3 in the present embodiment has a flat rectangular outer shape. In FIG. 1, the direction X, the direction Y, and the direction Z respectively indicate the thickness direction, the width direction, and the height direction of each battery cell 3.

The plurality of battery cells 3 are stacked and arranged in the direction X in the lower case 2. The battery module 1 in the present embodiment is provided with two battery assemblies arranged side by side in the direction Y, each assembly including the battery cells 3 stacked in the direction X. In actual use of the battery module 1, bus bars, pole terminals, an upper case, etc. are further attached to the battery module 1 in a state shown in FIG. 1; however, they are not important technical features of the present disclosure and thus they are omitted herein.

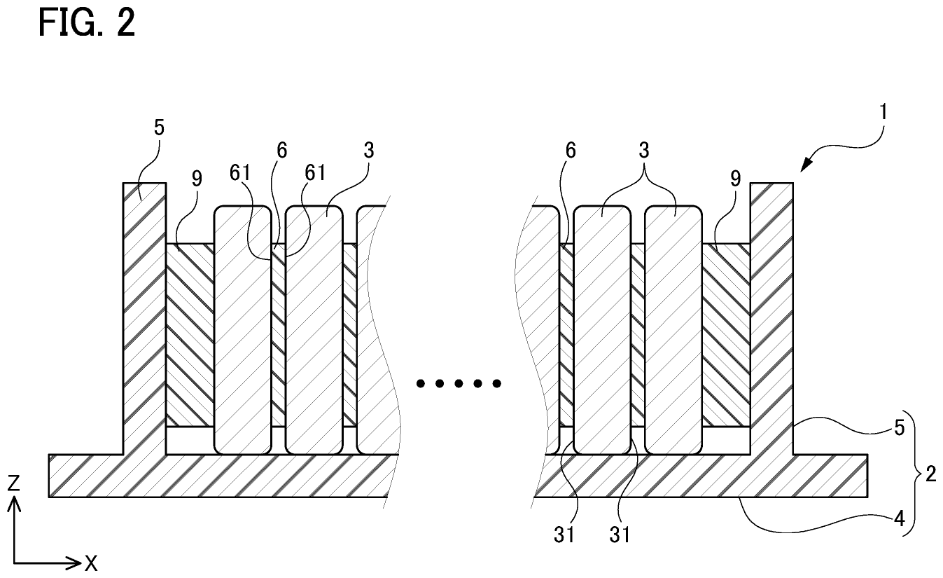

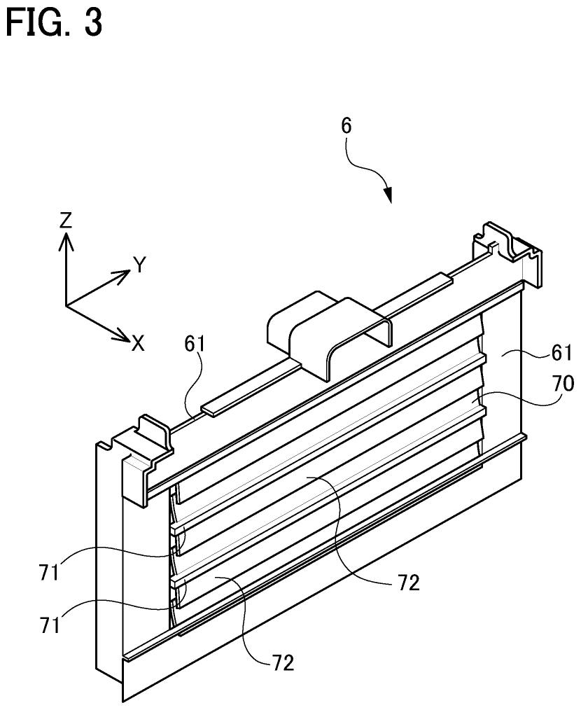

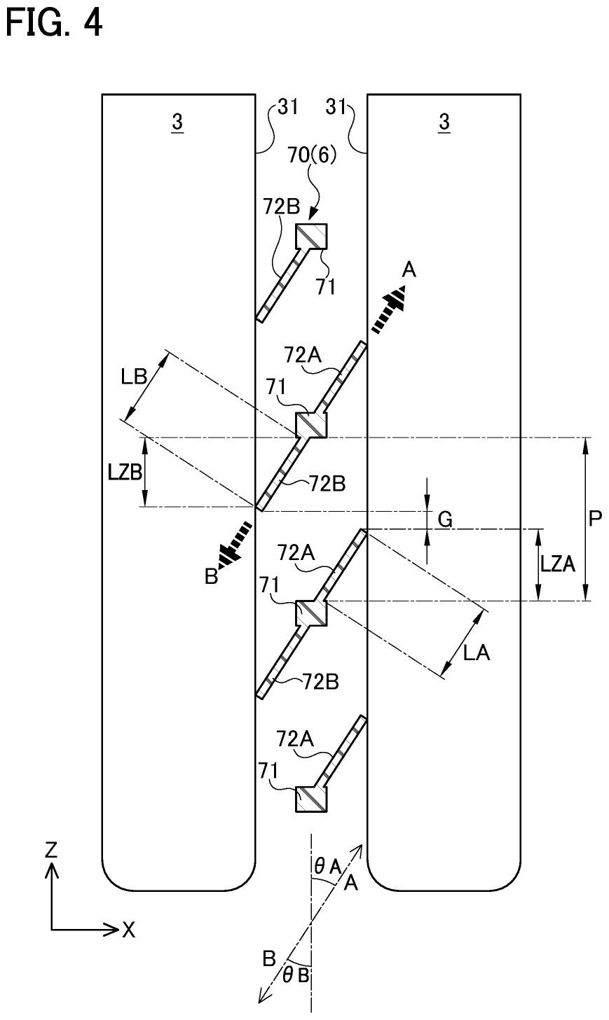

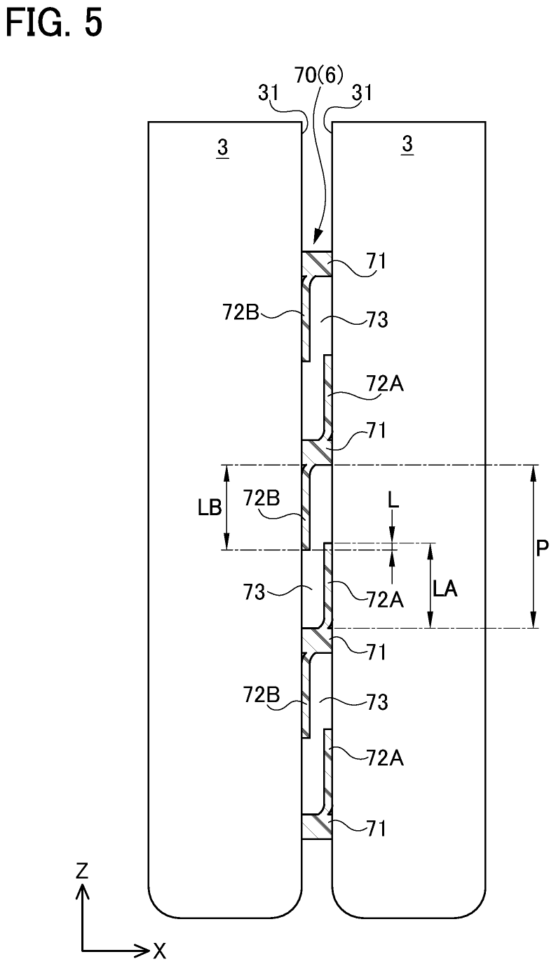

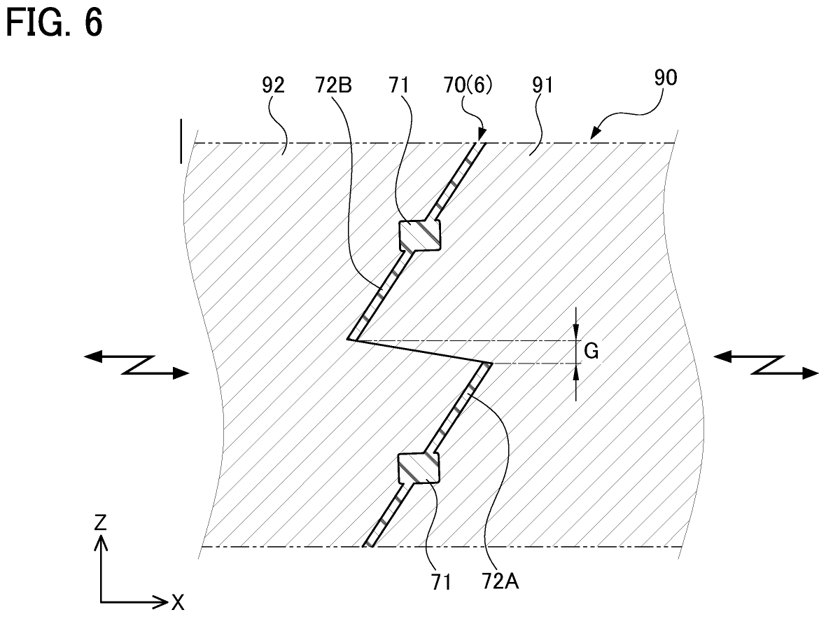

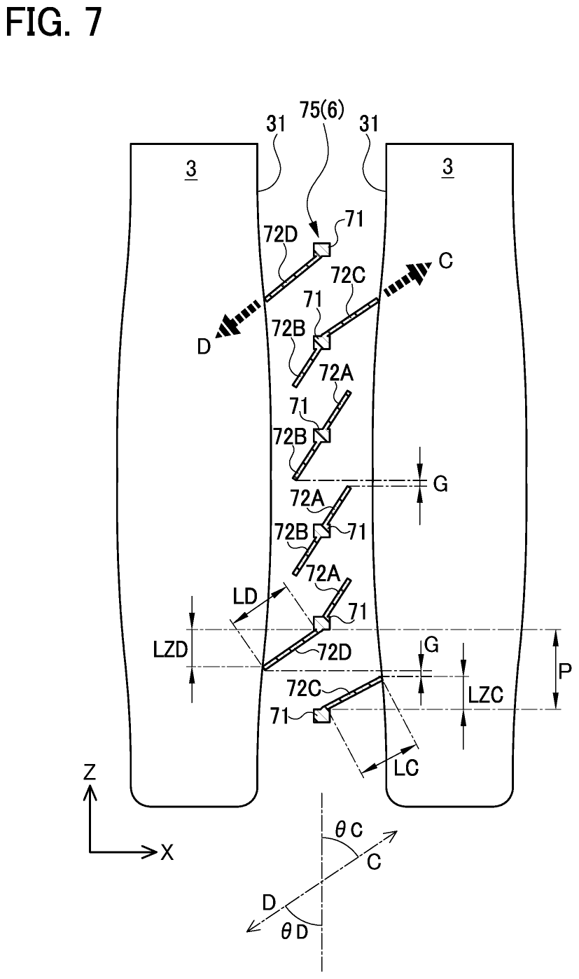

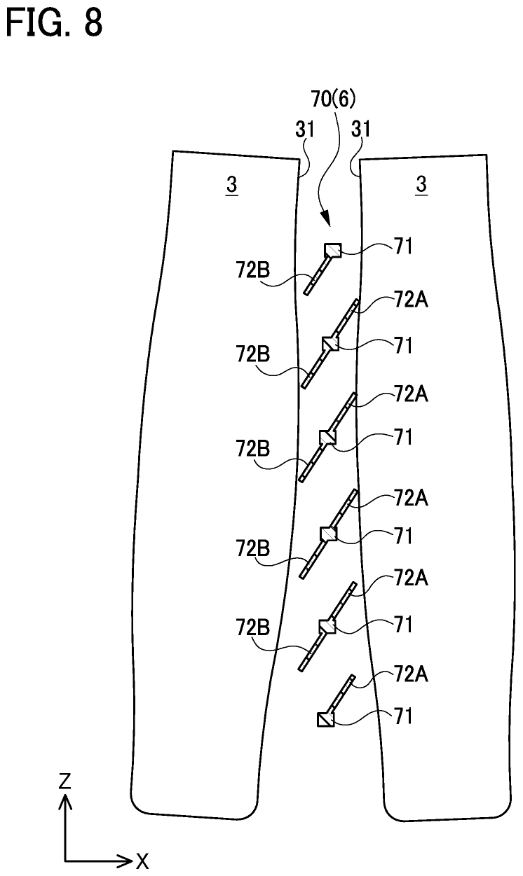

FIG. 2 is a cross-sectional view of the battery module 1 taken along A-A in FIG. 1. The lower case 2 includes, as shown in FIG. 2, a floor part 4 and end wall parts 5. The floor part 4 is located under the battery cells 3. The end wall parts 5 are located at both sides of the battery cells 3 in the direction X. In the lower case 2, the battery cells 3 are accommodated in a stacked form that the battery cells 3 and spacers 6 are alternately stacked. Between the endmost battery cell 3 and the end wall part 5 at each end in the direction X, an end plate 9 is held. All the spacers 6 and the end plates 9 are made of synthetic resin. In the present embodiment, the synthetic resin material of the spacers 6 and the end plates 9 has an electric insulation property and a certain degree of elasticity.

Each of the battery cells 3 has principal surfaces 31 on both sides in the direction X. In each battery cell 3 in the present disclosure, each of the principal surfaces 31 has a largest area among outer surfaces of each battery cell 3. Each of the spacers 6 has facing surfaces 61 that are located on both sides in the direction X and individually opposed to the principal surfaces 31 of the adjacent battery cells 3.

In the battery module 1, the battery cells 3, the spacers 6, and the end plates 9 are restrained in the direction X by the end wall parts 5 located outside those components 3, 6, and 9 in the direction X. Thus, the battery cells 3, the spacers 6, and the end plates 9 are subjected to compression load in the direction X. In the battery module 1, each of those battery cells 3, spacers 6, and end plates 9 is compressed in the direction X than in an uncompressed state.

FIG. 3 is a perspective view of the spacer 6. It is to be noted that the spacers 6 of the battery module 1 in the present embodiment are identical in structure, and only one of them is described below. Specifically, the spacer 6 includes a space-forming part 70 provided in the central region of the spacer 6 in both the direction Y and the direction Z. The space-forming part 70 is configured to form a space between the battery cells 3 adjacently located on both sides of the spacer 6.

In the spacer 6, the space-forming part 70 includes a plurality of bars 71 each extending in the direction Y. Specifically, each bar 71 is provided extending in a direction from one end to the other end (i.e., in the direction Y) of each principal surface 31 of the adjacent battery cells 3 in the direction Y. These bars 71 are arranged at spaced intervals from each other in the direction Z. Each bar 71 is provided with a fin part 72.

The space-forming part 70 will be described in detail below referring to FIGS. 4 and 5. FIGS. 4 and 5 both illustrate a cross-section of the space-forming part 70 of the spacer 6. Specifically, FIG. 4 shows the space-forming part 70 in an uncompressed state and the adjacent battery cells 3 and FIG. 5 shows the space-forming part 70 in a compressed state and the adjacent battery cells 3.

As shown in FIG. 4, each bar 71 is provided with at least a first fin 72A or a second fin 72B as the fin part 72. The first fin 72A is formed extending from the bar 71 in a direction indicated by an arrow A, namely, in a direction A. The second fin 72B is formed extending from the bar 71 in a direction indicated by an arrow B, namely, in a direction B. The direction A is one example of a first direction and the direction B is one example of a second direction in the present disclosure.

The direction A is an oblique direction from each bar 71 of the spacer 6 toward one battery cell 3 located on the right side of the spacer 6 in FIG. 4. The direction B is an oblique direction from each bar 71 of the spacer 6 toward the other battery cell 3 on the left side of the spacer 6 in FIG. 4. The direction B is an opposite direction to the direction A. In FIG. 4, the first fin 72A (the direction A) makes an acute angle θA with the direction Z and the second fin 72B (the direction B) makes an acute angle θB with the direction Z. In the present embodiment, the angle θA and the angle θB are equal to each other.

In the uncompressed state of the spacer 6, i.e., the space-forming part 70, shown in FIG. 4, the distal ends of the first fins 72A protrude toward the right battery cell 3 relative to the bars 71. In this uncompressed state, the distal ends of the second fins 72B protrude toward the left battery cell 3 relative to the bars 71. Thus, the bars 71 are neither in contact with the principal surface 31 of the right battery cell 3 nor the principal surface 31 of the left battery cell 3.

Each first fin 72A has a fin length LA, which is an extending length from the corresponding bar 71, and each second fin 72B has a fin length LB, which is an extending length from the corresponding bar 71. Each of the fin length LA and the fin length LB is smaller than the interval P between the adjacent bars 71. In the present embodiment, the fin length LA of each first fin 72A is equal to the fin length LB of each second fin 72B. Furthermore, the sum of the fin length LA of the first fin 72A and the fin length LB of the second fin 72B is set larger than the interval P of the bars 71.

Moreover, each first fin 72A with the fin length LA has a projected length LZA with respect to an arrangement direction of the bars 71 (i.e., the direction Z in FIG. 4), that is, on the principal surface 31 of the right battery cell 3, and each second fin 72B with the fin length LB has a projected length LZB with respect to the arrangement direction of the bars 71, that is, on the principal surface 31 of the left battery cell 3. These projected lengths LZA and LZB respectively indicate the length of the first fin 72A and the length of the second fin 72B in the arrangement direction. In the uncompressed state of the space-forming part 70, the sum of the projected length LZA of the first fin 72A of one of the adjacent bars 71 and the projected length LZB of the second fin 72B of the other bar 71 is set smaller than the interval P between these adjacent bars 71. In the uncompressed state, accordingly, a distal end of the first fin 72A and a distal end of the second fin 72B between the adjacent bars 71 are spaced with a gap G in the direction Z.

Of the plurality of bars 71 in FIG. 4, two bars 71 at both ends in the arrangement direction of the bars 71 are provided with only the first fin 72A or the second fin 72B. To be specific, the bar 71 located at each end in the arrangement direction of the bars 71 is provided with the first fin 72A or the second fin 72B, which extends inward, i.e., toward the center of the space-forming part 70, in the arrangement direction.

In the compressed state shown in FIG. 5, the right side of each bar 71 is in contact with the principal surface 31 of the right battery cell 3, while the left side of each bar 71 is in contact with the principal surface 31 of the left battery cell 3. In other words, in the compressed state, the bars 71 sandwiched between the opposed principal surfaces 31 of the adjacent battery cells 3 are compressed in the direction X and also press against the principal surfaces 31 of the adjacent battery cells 3 in directions away from each other due to reaction force to the compression. This configuration prevents the adjacent battery cells 3 from contacting each other at the positions of the bars 71. Thus, the separated principal surfaces 31 of the battery cells 3 on both sides of the spacer 6 form a space 73 between the bars 71 adjacently located above and below.

The first fins 72A are in contact with the principal surface 31 of the right battery cell 3 on the right side of the bars 71, so that the first fins 72A are pressed leftward by the principal surface 31 of the right battery cell 3. Due to this pressing, each first fin 72A is warped leftward along the principal surface 31 of the right battery cell 3 than in the uncompressed state. Each first fin 72A in this warped state extends upward along the principal surface 31 of the right battery cell 3. Due to the reaction force to the warping, the warped first fins 72A press the principal surface 31 of the right battery cell 3 rightward.

The second fins 72B are in contact with the principal surface 31 of the left battery cell 3 on the left side of the bars 71, so that the first fins 72B are pressed rightward by the principal surface 31 of the left battery cell 3. Due to this pressing, each second fin 72B is warped rightward along the principal surface 31 of the left battery cell 3 than in the uncompressed state. Each second fin 72B in this warped state extends downward along the principal surface 31 of the left battery cell 3. Due to the reaction force to the warping, the warped second fins 72B press the principal surface 31 of the left battery cell 3 leftward.

As described above, the fin length LA of each first fin 72A is smaller than the interval P between the adjacent bars 71. Accordingly, a part of the principal surface 31 of the right battery cell 3, within the interval P between the adjacent bars 71, is not covered by the first fin 72A. Further, the fin length LB of each second fin 72B is also smaller than the interval P between the adjacent bars 71. A part of the principal surface 31 of the left battery cell 3, within the interval P between the adjacent bars 71, is not covered by the second fin 72B. Therefore, the principal surfaces 31 of the battery cells 3 on both sides of the spacer 6 have a portion exposed to the space 73 within each interval P between the bars 71. In other words, when both the battery cells 3 located on both sides of the spacer 6 generate heat, this heat can be dissipated into the spaces 73. In the battery module 1 in the present embodiment, each space 73 serves as a cooling-gas passage allowing the gas for cooling the battery cells 3 to flow. Thus, the spacer 6 can prevent an increase in temperature difference between the adjacent battery cells 3 while cooling the adjacent battery cells 3.

As described above, furthermore, the sum of the fin length LA of the first fin 72A and the fin length LB of the second fin 72B is larger than the interval P between the adjacent bars 71. In the compressed state of the space-forming part 70, therefore, the first fin 72A of a lower one of two adjacent bars 71 located above and below and the second fin 72B of an upper bar 71 overlap each other in the arrangement direction of the bars 71. Specifically, the two adjacent, upper and lower, bars 71 are configured so that the distal end of the first fin 72A of the lower bar 71 and the distal end of the second fin 72B of the upper bar 71 overlap by an overlap distance L in the direction Z.

Since the bars 71 are configured as above, each first fin 72A presses at least a region of the right battery cell 3, which is opposite to a region of the left battery cell 3 not pressed by each second fin 72B. Each second fin 72B presses at least a region of the left battery cell 3, which is opposite to a region of the right battery cell 3 not pressed by each first fin 72A. In other words, the battery cells 3 on both sides of the spacer 6 are pressed by at least the first fins 72A or the second fins 72B in a direction to separate one from the other, without gap in the direction Z within each interval P between the adjacent bars 71.

Even when the battery cell(s) 3 is swollen from any cause, the spacer 6 can press the swollen battery cell(s) 3 through the first fins 72A and the second fins 72B and thus prevent the principal surface(s) 31 of the battery cell(s) 3 from entering into the space 73. Specifically, even when the battery cell(s) 3 is swollen, the spacer 6 can prevent narrowing of the space 73 in the direction X and appropriately maintain the space 73. The thus configured spacer 6 can suppress the reduction in flow rate of the cooling gas that flows through the space 73 due to swelling of the battery cell(s) 3. Accordingly, this spacer 6 can prevent deterioration of the cooling function of the cooling gas that flows through the space 73 to cool the battery cell(s) 3.

In the compressed state, furthermore, the first fin 72A of one of the two adjacent bars 71 arranged above and below and the second fin 72B of the other bar 71 overlap each other in the arrangement direction of the bars 71. Thus, the battery cells 3 disposed on both sides of the spacer 6 do not contact each other between the bars 71. This is because, for example, even when the adjacent battery cells 3 are swollen, entering into the space 73 by warping the corresponding first fins 72A and the second fins 72B, at least the first fins 72A or the second fins 72B always exist between the adjacent battery cells 3. The spacer 6 can therefore reliably maintain the adjacent battery cells 3 in insulated relation from each other.

In the uncompressed state of the spacer 6, the sum of the projected length LZA of the first fin 72A and the projected length LZB of the second fin 72B is smaller than the interval P between the adjacent bars 71. Accordingly, the first fin 72A of a lower bar 71 of two adjacent bars 71 arranged above and below and the second fin 72B of an upper bar 71 do not overlap in the arrangement direction of the bars 71. Such a spacer 6 can be made at low costs.

FIG. 6 is a cross-sectional view showing a molding die 90 used to produce the spacer 6 by injection molding, including an enlarged view of a part of the space-forming part 70. As shown in FIG. 6, the molding die 90 for the spacer 6 includes a first die 91 and a second die 92. These first die 91 and second die 92 are configured to hold a produced spacer 6 from both sides in the direction X and to be movable in the direction X. As described above, in the spacer 6, two adjacent bars 71 are arranged above and below such that the distal end of the first fin 72A provided to a lower bar 71 and the distal end of the second fin 72B provided to an upper bar 71 are spaced with a gap Gin the arrangement direction of the bars 71.

Therefore, the molding die 90 can be opened by moving the first die 91 and the second die 92 in opposite directions in the direction X without causing the first die 91 and the second die 92 to interfere with the spacer 6 produced by injection molding in the molding die 90. Specifically, the molding die 90 needs no additional sliding mechanism or the like that moves in a direction intersecting the moving direction of the first die 91 and the second die 92 to avoid the interference with the first fin 72A and the second fin 72B, which are made by molten resin injected into the die 90 and then solidified therein. The molding die 90 configured as above can be inexpensive and hence the spacer 6 can be produced at low costs.

In the battery module 1 in the present embodiment, as described in detail above, the plurality of battery cells 3 and the synthetic-resin spacers 6 are alternately stacked so that each spacer 6 is interposed between two battery cells 3. Each spacer 6 includes the plurality of bars 71 each extending in the direction Y, from one end to the other of each principal surface 31 of the adjacent battery cells 3, and are spaced in the direction Z at the interval P from each other. Each spacer 6 further includes at least the first fin 72A or the second fin 72B in each bar 71. Before the spacers 6 are assembled in the battery module 1, each first fin 72A obliquely extends from the corresponding bar 71 toward one of the adjacent battery cells 3 located on both sides of each spacer 6. Before the spacers 6 are assembled in the battery module 1, similarly, each second fin 72B obliquely extends from the corresponding bar 71 toward the other battery cell 3, i.e., in an opposite direction to the obliquely extending direction of the first fins 72A. While the spacers 6 are assembled and restrained in the battery module 1 and thus compressed, the first fins 72A each take a shape extending from the corresponding bar 71 toward one of the battery cells 3 and upward from the corresponding bar 71 and contacting the principal surface 31 of the battery cell 3. While the spacers 6 are assembled and restrained in the battery module 1 and thus compressed, similarly, the second fins 72B each takes a shape extending from the corresponding bar 71 toward the other battery cell 3 and downward from the corresponding bar 71 and contacting the principal surface 31 of the other battery cell 3. The fin length LA of the first fin 72A which is an extending length from the corresponding bar 71 and the fin length LB of the second fin 72B which is an extending length from the corresponding bar 71 are each smaller than the interval P between the adjacent bars 71. Furthermore, the sum of the fin length LA of the first fin 72A and the fin length LB of the second fin 72B is larger than the interval P between the adjacent bars 71. Accordingly, the first fin 72A and the second fin 72B can make sure that the space 73 is formed between the bars 71 with an appropriate dimension between the adjacent battery cells 3. This is because the first fins 72A can press regions of the battery cell 3 located opposite to regions not pressed by the second fins 72B in the arrangement direction of the bars 71. The same applies to the second fins 72B. This configuration can prevent, for example, the principal surface 31 of the swollen battery cell 3 from entering into the space 73 formed between the bars 71. Thus, the heat from the adjacent battery cells 3 can be appropriately dissipated into the space 73 between the bars 71. Consequently, the present embodiment can achieve the battery module and the spacers capable of appropriately cooling the battery cells with the space appropriately maintained between the battery cells. In the spacers 6, moreover, the sum of the projected length LZA of the first fin 72A and the projected length LZB of the second fin 72B with respect to the arrangement direction of the bars 71 is smaller than the interval P between the bars 71. Accordingly, the spacers 6 can be manufactured at low costs without the use of any complicated die.

### Second Embodiment

A second embodiment, different from the foregoing first embodiment, will be described below. This second embodiment differs from the first embodiment in the configuration of a space-forming part of a spacer. Other parts or components are identical to those in the first embodiment. The following description will be therefore focused on the space-forming part different from that of the first embodiment.

FIG. 7 is a cross-sectional view of a space-forming part 75 of a spacer 6 taken in the direction X in the present embodiment. In FIG. 7, the space-forming part 75 is in an uncompressed state. In the present embodiment, as shown in FIG. 7, the spacer 6 is provided with a plurality of fins, each of which extends from each bar 71 toward either one of the battery cells 3 located on both sides of the spacer 6. The space-forming part 75 in the present embodiment differs from the first embodiment in that a first fin and a second fin located at each end in the arrangement direction of the bars 71 are a first fin 72C and a second fin 72D. Of the bars 71 arranged in the direction Z, specifically, the bar or bars 71 located on the center side, i.e., at or near the center, in the arrangement direction are each provided with the first fin 72A and the second fin 72B. In contrast, the other bar or bars 71 located on each end side, i.e., at or near each end, in the arrangement direction are each provided with at least the first fin 72C extending toward the right battery cell 3 or the second fin 72D extending toward the left battery cell 3.

The first fin 72C obliquely extends from the bar 71 toward the right battery cell 3 in a direction indicated by an arrow C, namely, a direction C. The second fin 72D obliquely extends from the bar 71 toward the left battery cell 3 in a direction indicated by an arrow D, namely, a direction D. The direction D is opposite to the direction C. The direction C is one example of the first direction and the direction D is the second direction in the present disclosure. In FIG. 7, the first fin 72C (the direction C) makes an acute angle θC with the direction Z and the second fin 72B (the direction D) makes an acute angle θD with the direction Z. In the present embodiment, the angle θC and the angle θD are equal to each other. In the uncompressed state of the spacer 6, i.e., the space-forming part 75, shown in FIG. 7, the distal ends of the first fins 72C protrude toward the right battery cell 3 relative to the bars 71. In this uncompressed state, the distal ends of the second fins 72D protrude toward the left battery cell 3 relative to the bars 71.

Each first fin 72C has a fin length LC, which is an extending length from the corresponding bar 71, and each second fin 72D has a fin length LD, which is an extending length from the corresponding bar 71. Each of the fin length LC and the fin length LD is smaller than the interval P between the adjacent bars 71. In the present embodiment, the fin length LC of each first fin 72C is equal to the fin length LD of each second fin 72D. Furthermore, the sum of the fin length LC of the first fin 72C and the fin length LD of the second fin 72D is set larger than the interval P of the bars 71. In the compressed state of the space-forming part 75, therefore, the first fin 72C of a lower one of two adjacent bars 71 located above and below and the second fin 72D of an upper bar 71 overlap each other in the arrangement direction of the bars 71. Accordingly, in the present embodiment, as in the first embodiment, the space-forming part 75 of the spacer 6 in the compressed state can appropriately form the space between the adjacent battery cells 3, thereby preventing the deterioration of the cooling function of the cooling gas that flows through the space to cool the battery cells 3. The spacer 6 in the present embodiment can also reliably maintain the adjacent battery cells 3 in insulated relation from each other.

Furthermore, the fin length LC of the first fin 72C and the fin length LD of the second fin 72D are respectively larger than the fin length LA of the first fin 72A and the fin length LB of the second fin 72B. This configuration can suppress the adjacent battery cells 3 from inclining from one to the other.

FIG. 7 illustrates the battery cells 3 in a swollen state. The battery cells 3 tend to swell more greatly in the central portion in the direction Z corresponding to the height direction than each end portion as shown in FIG. 7. For the spacer 6 including the fins having the same fin length, if the battery cell(s) 3 largely swells, the battery cell(s) 3 may incline, as shown in FIG. 8, causing the principal surface(s) 31 to contact with the first fin(s) 72A and the second fin(s) 72B located on one end side in the direction Z.

For the above-mentioned configuration that the fins have the same fin length, a center or nearly center portion of the principal surface 31 of the swollen battery cell 3 can be appropriately pressed by the first fins 72A and the second fins 72B. However, an end or nearly end portion of the principal surface 31 of the swollen battery cell 3 in the direction Z is apt to be insufficiently pressed by the first fins 72A and the second fins 72B. Thus, such a battery cell 3 is likely to incline, causing the principal surface 31 to contact only the bars 71 on one end side in the direction Z. FIG. 8 shows an example that the battery cells 3 on both sides of the spacer 6 incline and thus the interval between their principal surfaces 31 is narrower on an upper side than a lower side.

If the battery cell(s) 3 inclines as above, the passages for the cooling gas formed between the bars 71 become different in cross-sectional area in the direction Z. In this case, the battery cell 3 cannot be uniformly cooled on both of one end side and the other end side in the direction Z. Further, if many of the stacked battery cells 3 constituting a battery assembly are inclined, the stacking direction of the battery cells 3 will be meandering.

In contrast, in the second embodiment as described above in which the first fins 72C and the second fins 72D, each having a longer fin length than the the first fins 72A and the second fins 72B, are arranged on each end side in the direction Z, the battery cell(s) 3 is prevented from inclining even if the battery cell(s) 3 adjacent to the spacer 6 swells on the center side. This is because both end portions of each battery cell 3 in the direction Z can be appropriately pressed by those longer first fins 72C and second fins 72D. Accordingly, the stacked battery cells 3 constituting a battery assembly can be aligned in a straight arrangement in the stacking direction. Further, a plurality of passages for cooling gas arranged in the direction Z in the space-forming part 75 can have an equal or nearly equal dimension. Thus, both end portions of the battery cell 3 can be uniformly cooled in the direction Z.

The angle θC of the first fins 72C and the angle θD of the second fins 72D in FIG. 7 are respectively larger than the angle θA of the first fins 72A and the angle θB of the second fins 72B. Specifically, the first fins 72C and second fins 72D, which are longer than the first fins 72A and second fins 72B, have a larger inclination to the direction Z than the first fins 72A and second fins 72B. Consequently, in the spacer 6 in the uncompressed state, the sum of a projected length LZC of the first fin 72C having the fin length LC with respect to the arrangement direction of the bars 71 and the projected length LZD of the second fin 72D having the fin length LD with respect to the arrangement direction of the bars 71 is set smaller than the interval P between the bars 71. In the uncompressed state, in other words, the longer first fin 72C and the longer second fin 72D located between the adjacent bars 71 also do not overlap each other in the arrangement direction of the bars 71 and thus the distal ends of those fins 72C and 72D are spaced with a gap G in the direction Z. In the present embodiment, as in the first embodiment, a molding die for producing the spacer 6 configured as above by injection molding can be inexpensive. This is because the molding die needs no additional sliding mechanism or the like to avoid the interference with the solidified first and second fins 72C and 72D. The spacer 6 in the present embodiment can also be produced at low costs.

In the spacer 6 of the battery module 1 in the present embodiment described in detail above, the bars 71 on each end side in the arrangement direction are provided with at least the first fin 72C or the second fin 72D. The fin length LC of the first fin 72C and the fin length LD of the second fin 72D provided to the bars 71 on each end side are longer than the fin length LA of the first fin 72A and the fin length LB of the second fin 72B provided to the bars 71 on the center side. Even if a portion of the battery cell(s) 3 located on the center side, namely, a center-side portion of the battery cell(s) 3, swells in the battery module, the first fins 72C and the second fins 72D, each having a longer fin length, can appropriately press a portion of the battery cell(s) 3 located on each end side, namely, an end-side portion of the battery cell(s) 3. Thus, the space between the battery cells can be ensured uniformly in the arrangement direction of the bars, leading to appropriate cooling of the battery cell.

The foregoing embodiments are mere examples and give no limitation to the present disclosure. The present disclosure may be embodied in other specific forms without departing from the essential characteristics thereof.

For example, the foregoing embodiments exemplify the configurations that the arrangement direction of the bars corresponds to the height direction of each battery cell. As an alternative, the arrangement direction of the bars may correspond to the width direction of each battery cell. Moreover, the number of bars and other conditions in the aforementioned embodiments are mere examples and may be changed as needed.

The foregoing embodiments can be applied to every type of batteries, such as nickel hydride batteries, lithium-ion batteries, without any particular limitations.

The battery module according to the present disclosure may be configured such that the first fin length of the first fin and the second fin length of the second fin provided to the bars located on an end side in an arrangement direction of the bars are respectively longer than the first fin length of the first fin and the second fin length of the second fin provided to the bars located on a center side in the arrangement direction of the bars. With this configuration, even if a center-side portion of the battery cell of the battery module may largely swell, the first fin and the second fin each having a longer fin length can appropriately press an end-side portion of the battery cell. This configuration can uniformly maintain the space between the battery cells in the arrangement direction of the bars.

The spacer according to the present disclosure may be configured such that the first fin length of the first fin and the second fin length of the second fin provided to the bars located on an end side in the arrangement direction of the bars are respectively longer than the first fin length of the first fin and the second fin length of the second fin provided to the bars located on a center side in the arrangement direction of the bars. With this configuration, even if a center-side portion of the battery cell of the battery module may largely swell, the first fin and the second fin each having a longer fin length can appropriately press an end-side portion of the battery cell. This configuration can uniformly maintain the space between the battery cells in the arrangement direction of the bars.

Reference Signs List

| | |
|---|---|
| 1 | Battery module |
| 3 | Battery cell |
| 6 | Spacer |
| 31 | Principal surface |
| 71 | Bar |
| 72 | Fin part |
| 72A, 72C | First fin |
| 72B, 72D | Second fin |

What is claimed is:

1. A battery module comprising:
a plurality of battery cells, each having a principal surface; and
a plurality of spacers made of synthetic resin and each placed between the battery cells so that the battery cells and the spacers are alternately stacked one on another,
wherein each of the spacers comprises:
a plurality of bars provided extending in a direction from one end to another end of each principal surface of the battery cells adjacently located on both sides of each spacer, the bars being arranged at an interval from each other;
a first fin extending from at least one of the bars toward one of the adjacent battery cells and in a first direction from the bars and contacting the principal surface of the one battery cell; and
a second fin extending from at least one of the bars toward another battery cell of the adjacent cells and in a second direction from the bars, opposite to the first direction, and contacting the principal surface of the other battery cell,
the first fin has a first fin length which is an extending length from the bar in the first direction and the second fin has a second fin length which is an extending length from the bar in the second direction,
each of the first fin length and the second fin length is smaller than an interval between the bars, and
a sum of the first fin length and the second fin length is larger than the interval between the bars.

2. The battery module according to claim 1, wherein the first fin length of the first fin and the second fin length of the second fin provided to the bars located on an end side in an arrangement direction of the bars are respectively longer than the first fin length of the first fin and the second fin length of the second fin provided to the bars located on a center side in the arrangement direction of the bars.

3. A spacer made of synthetic resin and to be placed between a plurality of battery cells each having a principal surface and constituting a battery module, the spacer comprising:
a plurality of bars provided extending in a direction from one end to another end of each principal surface of the battery cells adjacently located on both sides of the spacer, the bars being arranged at an interval from each other;
a first fin extending from at least one of the bars toward one of the battery cells in an oblique direction; and
a second fin extending from at least one of the bars toward another battery cell and in an oblique direction opposite to the oblique direction of the first fin,
wherein the first fin has a first fin length which is an extending length and the second fin has a second fin length which is an extending length,
each of the first fin length and the second fin length is smaller than an interval between the bars,
a sum of the first fin length and the second fin length is larger than the interval between the bars, and
a sum of a projected length of the first fin with the first fin length with respect to an arrangement direction of the bars and a projected length of the second fin with the second fin length with respect to the arrangement direction of the bars is smaller than the interval between the bars.

4. The spacer according to claim 3, wherein the first fin length of the first fin and the second fin length of the second fin provided to the bars located on an end side in the arrangement direction of the bars are respectively longer than the first fin length of the first fin and the second fin length of the second fin provided to the bars located on a center side in the arrangement direction of the bars.
